(19) United States
(12) Patent Application Publication
(10) Pub. No.: US 2014/0176606 A1
(43) Pub. Date: Jun. 26, 2014

(54) RECORDING AND VISUALIZING IMAGES USING AUGMENTED IMAGE DATA

(71) Applicant: Analytical Graphics Inc., Exton, PA (US)

(72) Inventors: Shashank NARAYAN, Exton, PA (US); Paul GRAZIANI, Wayne, PA (US)

(73) Assignee: Analytical Graphics Inc., Exton, PA (US)

(21) Appl. No.: 14/136,357

(22) Filed: Dec. 20, 2013

Related U.S. Application Data
(60) Provisional application No. 61/740,122, filed on Dec. 20, 2012.

(51) Int. Cl. G06T 11/60

(52) U.S. Cl. CPC G06T 11/60
USPC 345/633

(57) ABSTRACT

A device and method for presenting augmented image data. An image capture device captures an image together with information about the image. Alternatively a data logger may capture additional information about a particular image. The image and additional information is sent to a database where a server analyzes the augmented image and relates the augmented image to other images in the database. A subsequent user may query the database for all images and augmented information for a particular area, location, or object and retrieve that collected information for subsequent analysis.

### CROSS REFERENCE TO RELATED APPLICATIONS

This application claims the benefit of Provisional Application No. 61/740,122 filed Dec. 20, 2012. The 61/740,122 application is incorporated by reference herein, in its entirety, for all purposes.

### BACKGROUND

Image databases exist for a wide variety of purposes. More digital images are being stored in databases both in “servers” and in the “cloud” for archival purposes. More flexible was of using image databases are constantly being sought for a wide variety of purposes.

### SUMMARY

Various embodiments described herein utilize a data visualization server to provide 3D viewing functionality to desktops and to mobile platforms, either locally or via the web.

In an embodiment, the data visualization server incorporates metadata with photographic and video data to provide social and situational awareness to videos and still images. For example, metadata may include position and orientation information of videos and photos taken using mobile devices. The data visualization server utilizes this information to augment the video and/or photographic data so as to provide a unique way of visualizing videos and photos.

In an embodiment, the system can intelligently predict based on minimal information from users how a particular image was acquired at a particular location at any point in time.

The data visualization server of the various embodiments displays videos and photos by introducing the element of time as a 4th dimension (4D) to present information that is temporally relevant to the images acquired. This provides situational awareness to most common home videos and photos, and provides a way of visualizing them. Mobile applications and widgets can also be embedded in web based social networks and regular web pages as a way of publishing videos and still images.

Various embodiments described herein provide a way of displaying photos, and telling a story in the process. This is different than viewing a regular photo album without any context.

By storing information in the database that is both temporally and geographically relevant to the image being viewed, the element of time as a new dimension is added to viewing photos and videos. A built-in time line tool communicates this additional information to a user.

Various embodiments capture and utilize orientation and geographic location of the camera to overlay photos and videos appropriately. Other applications allow users to share photos and videos in the immersive environment in a social network.

### DESCRIPTION OF THE DRAWINGS

FIG. 1A is a block diagram illustrating a data visualization server according to an embodiment.

FIG. 1B illustrates a 3D visualization of the globe together with timeline according to an embodiment.

FIG. 2 illustrates a view of an African Safari vacation derived from GPS logs and GPS tagged photos according to an embodiment.

FIG. 3 illustrates placement of a person-icon which is now in the image on April 1^{st} based on the GPS information according to an embodiment.

FIG. 4 illustrates that clicking on the camera icon displays photos (and videos) based on that location of that camera icon according to an embodiment.

### DETAILED DESCRIPTION

As used herein, “image data” encompasses data acquired from any image producing sensor or device whether in the visible spectrum, infrared region of the spectrum, photographic or still images and data acquired from video data.

As used herein, “image metadata” encompasses a data about image data. For example, metadata may include a time and date an image was captured, a location where the image was captured, information about the image capture device that was used to acquire the image data, an orientation of the image capture device when the image was captured, an angle of the image capture device when the image was captured, a direction in which the image capture device was pointed, when the image was captured, a relationship in time and geographic location between multiple images, exposure conditions, focal length, aperture settings and similar data.

As used herein, an image “sensor” encompasses the component of an image capture device that senses light and stores the sensed light as image data.

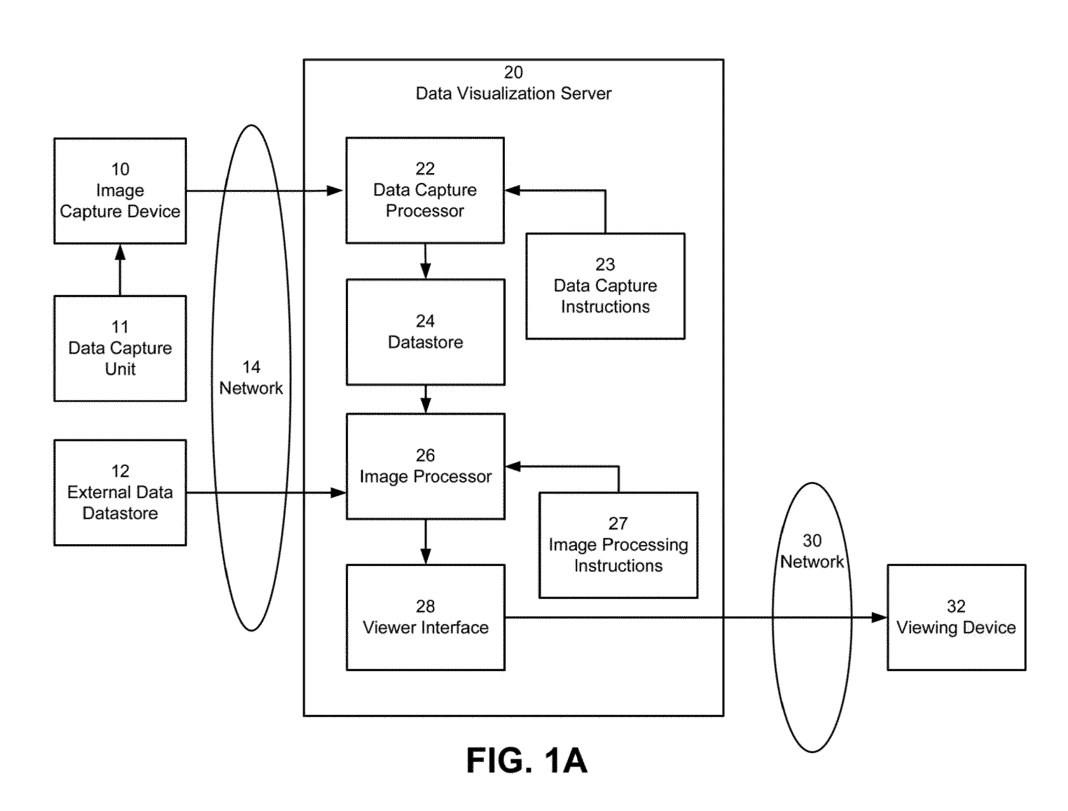

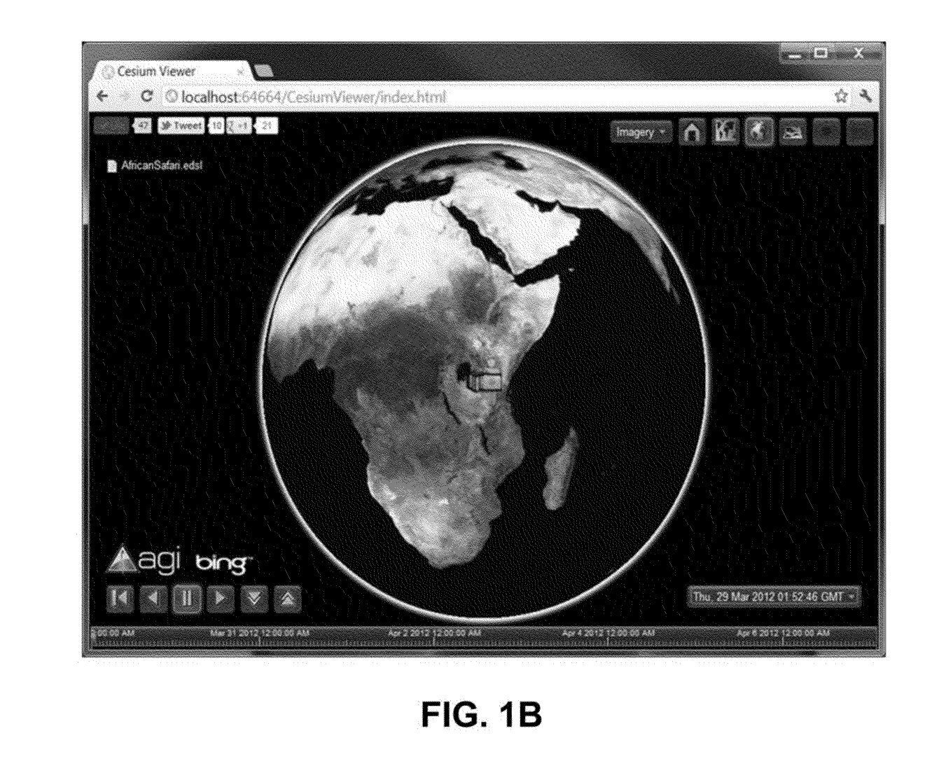

FIG. 1A is a block diagram illustrating a data visualization server according to an embodiment.

A data visualization server 20 receives image data and image metadata from an image capture device 10 via a network 14. The image metadata may be acquired by the image captured device 10. Alternatively, the image metadata may be acquired by a data capture unit 11 and provided to the image capture device 10.

The image capture device 10 may be a camera, a video capture device, a smart phone, a tablet computer, or any other device that can capture a still or a video image.

The image data and the image metadata are received by a data capture processor 22. The data capture processor 22 operates on the image data and the image metadata using data capture instructions 23 to produce an image record that is stored in a datastore 24. The datastore 24 may be local to the data visualization server 20 or it may be cloud based.

In an embodiment, a record stored in the datastore 24 is an augmented image that includes the image data, and all of the other information concerning the conditions under which the image is captured.

In an embodiment, the image data and/or the image metadata are associated with an identifier that is provided to the data capture processor 22 and is used to index the image record that is stored in the datastore 24. In an embodiment, the identifier may be associated with a user of image capture device 10 and may be used by the user to access the image records generated by the image capture device 10. By way of illustration and not by way of limitation, the identifier may be a unique code associated with the image capture device 10.

In an embodiment, an image processor receives records from the datastore 24 and optionally external datastore 12 and performs operations in accordance with the image processing instructions 27. A viewer interface 28 receives results from the image processor 26 and makes those results available to a viewing device 32 via a network 30. The viewing device 32 may be a desktop computer, a laptop computer, a smart phone 20, or any other device capable of viewing image and text data.

While the image capture device 10 and the viewing device 32 are illustrated as separate devices, this is not meant as a limitation. In an embodiment, the functions of the image capture device 10 and the viewing device 32 are performed by a single device.

In an embodiment, a data visualization server 20 is configured to receive and store images in an image database, to receive and store camera orientation data for each image in the image database, to receive and store a time of image acquisition for each image in the image database; to create a timeline for selected images in the image database, to overlay the timeline on a digital terrain database, the timeline overlay comprising icons indicating where a specific image from the image database occurs in the timeline overlay. The data visualization server 20 may be further configured to allow a user to select a specific image from the timeline overlay and to display the selected image to the user together with the orientation data and the time of image acquisition.

The data visualization server 20 may also be configured to provide for receiving and storing geographic information relating to each image in the image database and for displaying geographic information in association with the selected image designated by a user. The data visualization server 20 may also provide geographic information associated with a selected image by displaying an icon associated with the selected image on a map of the Earth's surface.

In an embodiment, the datastore 24 indexes images based in part on geographic locations and in part on the image metadata for images that are stored. This indexing allows a user to search the image database for images of an object taken at a particular location at different times and by different devices and/or users. Further, the data visualization server 20 may be configured to advise users of the presence of the additional images in regions previously searched by that user, allowing the user to select and display the additional images with augmented data.

In an embodiment, the data visualization server 20 uses GPS data logs associated with objects in the image to place a representation of an image in the image datastore 24 in the proper geographic location on a map. A GPS data log is obtained from individual GPS logging equipment or other sources of position data. For example but without limitation, in an embodiment the GPS data log is obtained from a GPS logging capability integrated with a sensor from which the image is obtained.

The system also allows different types of images. By way of illustration and not by way of limitation, images in the image database may be still images or a video stream of images.

In an embodiment, a single image may be combined by the image processor 26 with other images to arrive at a three-dimensional rendering of objects captured as collective images. In addition to the fourth dimension of time, a “fifth dimension” may be obtained by combining the image and time information together with news articles, reports, or other information relating to the geographic location and/or the objects captured in the image.

In another embodiment, the image processor may operate on a particular image to assemble that image with other images of the same location or with additional subject matter so that an edited augmented image, or combination of images may be created for later sharing. This type of activity may involve obtaining additional information that can augment data concerning any particular image in question.

In an embodiment, an analysis of the imagery that is collected includes a determination of orientation and position of the image capture device in geographic terms, of the angle of the image capture device relative to the images captured, and other features. Further, if the image is part of a series of images, as in the case where a traveler has taken a number of pictures over a period of time, a map may be created showing the geo-spatial relationship of one image to another. In an embodiment, the images may be associated with a user or with a device by an identifier. The identifier may then be used to collect images for inclusion on the map. By way of illustration and not by way of limitation, the identifier may be a unique code associated with the image capture device 10.

For other images in the same geographic area, the data capture processor inn log the geographic location of all images in a particular area. This enables a subsequent user to determine the relative location of one image to another even if those images were not captured by the same image capture device. Using known data about an object in the image, the sensor angle may be determined. Other data may allow other calculation. For example, shadow and time of day data may be used to determine heights and distances.

In an embodiment, a user may browse the database of augmented images and then be able to request information concerning an image of interest, and subsequently obtain its location relative to locations of other images. The user may also be able to obtain information concerning events happening at roughly the same time as when any particular image was obtained. Other augmented information may also be stored even if that augmented information relates to another time period.

Referring now to FIG. 1B, an illustration of a visualization created by the various embodiments can be seen. In this illustration, a globe is created from a digital terrain database. This globe is accurate in all of the digital information that represents any particular geographic location based upon is database source. While a larger globe is depicted, a user can zoom into a particular geographic area and obtain further detail that is accurate to the level of the particular digital terrain database being used. In this illustration, the focus of the globe is on Africa.

In addition to the globe, a timeline is noted along the lower limit of the frame. Using this timeline, a user can designate a particular time and be presented with images that have been taken within a user definable limit surrounding a particular time relating to a particular location of interest, also defined by the user. In this fashion, a user can move a cursor along the timeline and see what images are being presented. Clicking on any particular image will give that image, as well as image information together with other user specified data augmentation.

Alternatively, a user can request to be presented with all images in a particular area. Clicking on any particular image will cause a pointer to be registered on the timeline so that a user can determine when a particular image of interest was acquired. Other buttons in the image can cause any related information to be shared with other similar minded individuals over social media.

Using the images and selected image information, the data visualization server 20 may create a symbolic timeline which can then be registered with and visually overlaid on a digital image of the area in which the individual images have been acquired. Further, where possible, each image has a time associated with the image acquisition, icons of the images can be overlaid on a digital terrain database so that the images are depicted in the order in which they were taken, overlaid on the digital terrain database.

In an embodiment, the data visualization server 20 can also connect individual images that are related in some fashion (e.g. a particular person has recorded their particular travel via images over a period of time) that are registered on the digital terrain database by a series of connecting lines so that the actual order and path taken by a person creating the image can be shown. In this way, those who view the images that are stored can also view the path taken by the individual user who created the images. This presentation would be in contrast to a presentation whereby the images are simply placed in a spot in a digital terrain database without any knowledge of the order in which the images were taken.

Ancillary data can also be created in an embodiment, using the image related data that is stored by the user. Thus, when a user clicks on an iconic representation of an image placed in an appropriate location in a digital terrain database, information about that image may be displayed including, but without limitation, the date, time of day, person taking the image, and other information about the image.

In yet another embodiment, once the images are displayed in the correct location in a digital terrain database, a user can select a specific image from the timeline overlay of images and view all image related data concerning that image. In this fashion, ancillary data including orientation of the image recording device together with time of day, date, and other information can be displayed, further enhancing the viewing experience.

Information Adding Function

It is anticipated in the various embodiments illustrated herein that certain of the data may be automatically transmitted along with the image that is to be placed in the database. Thus, for those image recording devices that have information such as exposure conditions, focal length, aperture settings, date and time, and other data, this information can be sent together with the image itself to create a record for that individual image.

It is also the case that other types of data loggers may be used in conjunction with acquiring an image. The record from these separate data loggers can also be sent as a separate file to the database and associated with a particular image so that a complete record of the image acquisition conditions can be maintained. Further, more sophisticated image acquisition systems have more complete records of conditions under which an image is created. Thus images that are sent to the database of the various embodiments herein can be as simple as the normal data collection function of a typical digital camera, or be a much more detailed record coming from multiple devices all of which associate their information with a particular image that has been recorded.

Once a database of images has been created, many applications for both scientific and other more casual recreational uses exist. For example, if a user has knowledge that a particular image was created at a particular location, and that user has access to the database of the various embodiments illustrated herein, the user can go to the precise spot at which a prior image was taken, retrieve the additional information about that image including its orientation, time of day of collection, date of collection, and other factors. Using this information, a subsequent user can create an image under virtually the same circumstances as a prior image in the database. In this fashion images can be Obtained that record the changes in an object as seen from the acquisition location of the prior image in the database.

This type of application may be used in all manner of planning functions, archaeological functions, disaster recovery, and in the tourism industry, to name but a few applications.

In addition to the above, when images are recorded in similar fashions, including image orientation, it is possible to perform image matching functions that will automatically identify differences between images. In this fashion it would be possible to track even minute changes in objects that are imaged at different times and dates.

The various embodiments noted herein are not limited to still images. It is equally applicable to use the various embodiments for motion images such as videos that are being taken as one traverses a particular area. In this embodiment, the sensor orientation is constantly recorded along with any video image that is collected. This information can later be used with subsequent image sensors to literally point the subsequent sensor in the same direction and in the same orientation as the original video sensor that recorded the prior video stream.

Information that is stored in the database of the various embodiments illustrated herein can also be used in other fashions. For example using the image orientation information, it will be possible to model and visualize the actual sensor itself as images were being taken. In this instance, one is interested in visualizing the sensor system and how it behaved during the course of creating the images that are stored in the database.

For example and without limitation, a photograph that is collected and stored in the database would comprise a digital image of object(s), a time when the image was taken, a point location of the sensor where taken, and an orientation of a sensor when the image was taken.

When a database of objects and locations are created using embodiments illustrated herein, one can then study images of the same object over time or from different angles, study many events from the same location over time, i.e. vary by the objects at or near the location where the original image was taken, vary the time of day for creating subsequent images and compare the visual representation of objects at different times of day, place the sensor at a particular point but collect images surrounding that particular point to view how surrounding areas may have changed over time and change the orientation of a sensor that is placed at the same location and time of day as an original image yet collect different views of various objects surrounding the collection point.

Using the various embodiments together with photogrammetric functionality, it is possible to create more detailed maps of where specific objects are with respect to the location where an original sensor was located. In this fashion, a city planner could create maps of buildings and other structures that existed within an area surrounding a particular point at which a sensor took an earlier image. With knowledge of the camera systems involved, the orientation, time of day, etc. it is possible to reconstruct the locations of objects in a particular image. Further, by viewing an additional image that may be at a slightly different point but in the same general area as an earlier image, using photogrammetric techniques and the information recorded in the database, it is possible to use intersection or resection functionality to arrive at precise locations for objects that are common to both images.

When referring to a video record various embodiments will allow a dynamic relationship between objects in subsequent videos to be modeled. While relationships between objects in the videos that are seen to have moved between videos can be modeled, it will also be possible to place other objects, which are not imaged in the videos into such videos in a digital fashion so that one can study the relationship between such newly embedded objects and those objects that already existed in the videos over a period of time.

Having a database created using the various embodiments illustrated herein, many other functions are possible. For example even though images may be recorded by different sensors at different times, having the additional information such as orientation, geographic location, and other data will allow different images from different sensors to be “stitched together” into an accurate mosaic of a larger area than that imaged by a single sensor alone.

Having created this enlarged area with associated positional information, such information can then be used to model vehicle locations, how a vehicle might negotiate a particular area (for example, a large crane moving through a city) and how crowds may have appeared in a particular area in an event that transpired recently or in the long distant past.

Law enforcement functionality may also be enhanced by the various embodiments illustrated herein. For example, crime scene reconstruction would benefit by a database of the type illustrated herein. Thus, police could reconstruct an area and how objects in the area existed relative to one another prior to a catastrophic event. This would enhance investigation of how such an event transpired.

After a catastrophic event, it is sometimes desirable to reconstruct an image of the affected area prior to the occurrence of the event so that rescue and recovery operation can be conducted, and subsequent reconstruction efforts can be mounted. In such a scenario, information from multiple sensors stored in the database as illustrated herein would be invaluable for such reconstruction.

Augmented Reality Processing

Still another functionality of the various embodiments illustrated herein is the application of “augmented reality” processing. Such processing involves the placement of additional objects, text, people, commercial advertisements, and other types of messaging into images. In such applications, a user may call up a particular image that was recorded and, because of the date and location information that is stored together with the image, be able to receive news items concerning what was happening at that particular location when the image was taken.

Augmented reality processing is accomplished in part by sorting information concerning the images into categories based upon use. By way of illustration and not by way of limitation, articles may be obtained about a particular location in a town concerning public improvements made at a location including sewers, drainage, construction techniques and the like (collectively “civil improvements”) that have taken place over the years. Population and residential information may also be obtained thereby denoting who lived in what structures and what the population of buildings is/was at any point in time. Still other information may be obtaining concerning the types of building materials used and the building codes that existed at the time of the construction of buildings in an image. GPS or geographic coordinates of buildings in an image may also be determined thereby allowing information to be registered to specific locations in an image.

By augmenting images in a database and registering images one to another, a subsequent analysis may take place in the event of, for example, a disaster. In the initial phases of recovery, a user may display a series of images to provide to first responders allowing the first responders to better assess who might have lived in certain structures so that a more directed search and rescue effort may be mounted.

In a reconstruction project for disaster recovery or urban renewal purposes, a user may search for images together with the civil improvements which were made over time to an area. In this fashion costs and reconstruction efforts may be better determined.

Similarly, a user who creates a particular image for the database of the various embodiments illustrated herein can also provide a summary of current events taking place at the time the image was collected. This recorded message can then be stored as an observation of a particular user of events occurring when the image was taken. This functionality would clearly be useful in an historical study and for tourism applications. However, it is equally the case that such recordings conserve an intelligence value since not only will precise information concerning a specific image be collected in a fairly automated fashion but that collected image can also record the observations relating to specific events in which a party may be interested.

Over a period of time, the database would be a fairly rich source of information of events that occurred at a particular location. This can be used for all manner of trend and event analysis. In such a case, a user may query the data visualization server 20 for images of events that occurred in a particular location at a particular time, or period of time, and receive textual information associated with each image of the events that occurred in that location so that an immediate analysis of recorded events can be conducted.

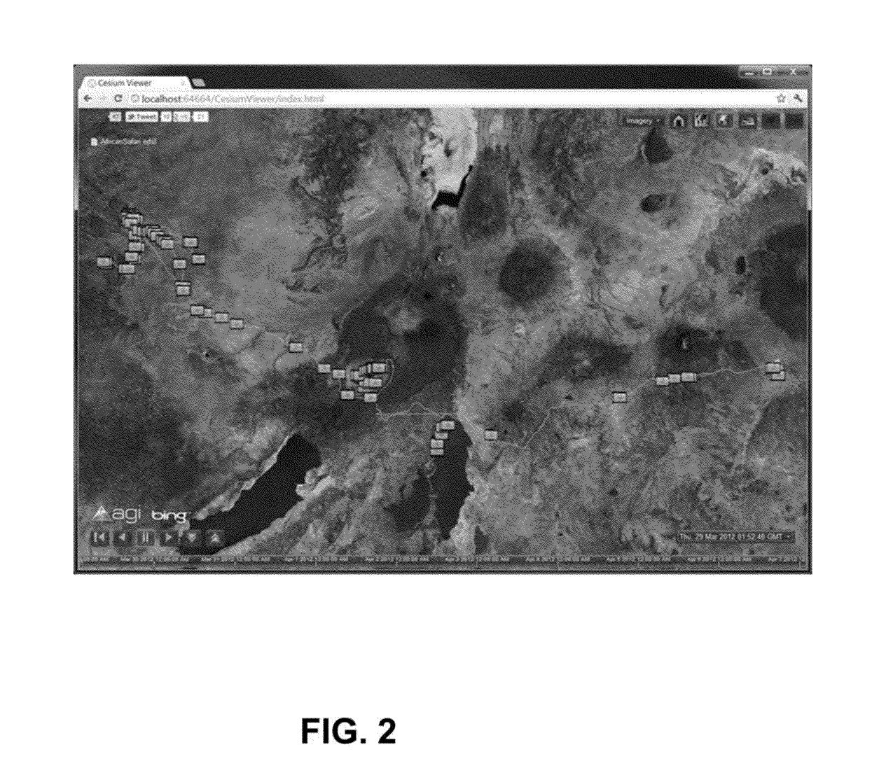

Referring now to FIG. 2, a view of an African Safari vacation derived from GPS logs and GPS tagged photos is illustrated. In this illustration, each photo that is taken during the vacation is sent to the database together with a global positioning system (GPS) log associated with each photo. Each photo is tagged as having a GPS log associated with it. Using this GPS log, an icon of the photo can be superimposed over digital terrain that allows geolocation of that photograph over the terrain where the photograph was taken.

The temporal connection of the photographs is illustrated by a line that connects each photograph in the series. It should be noted that, while other photographs may also have been taken in that geographic location, they will not be linked by a line since they are not designated as being part of the same vacation, or trip, as those that are connected by the line as illustrated.

Once again, at the bottom of the image, a timeline is illustrated. This timeline is adaptive, meaning that the user can establish that a timeline should be presented that encompasses the beginning of the trip and the end of the trip. Thus, not all timelines will cover the same amount of time. Rather, the timeline is adaptable to the trip duration. However, in all cases, the precise time of each photograph in the database is recorded and, when a user clicks on a particular image to be viewed, an indicator on the timeline is set so that the user can see where within the vacation the image was actually created.

As noted above in reference to FIG. 2, a user can also select a geographic area, point to the area, and request a representation of all images that were taken in a particular area. Clicking on any particular image will provide a date and time of when that image was recorded. Further choices given to a user can allow other information to be presented such as textual information concerning current events at the time the image was taken as well as audio recordings made by those who took the particular image of interest.

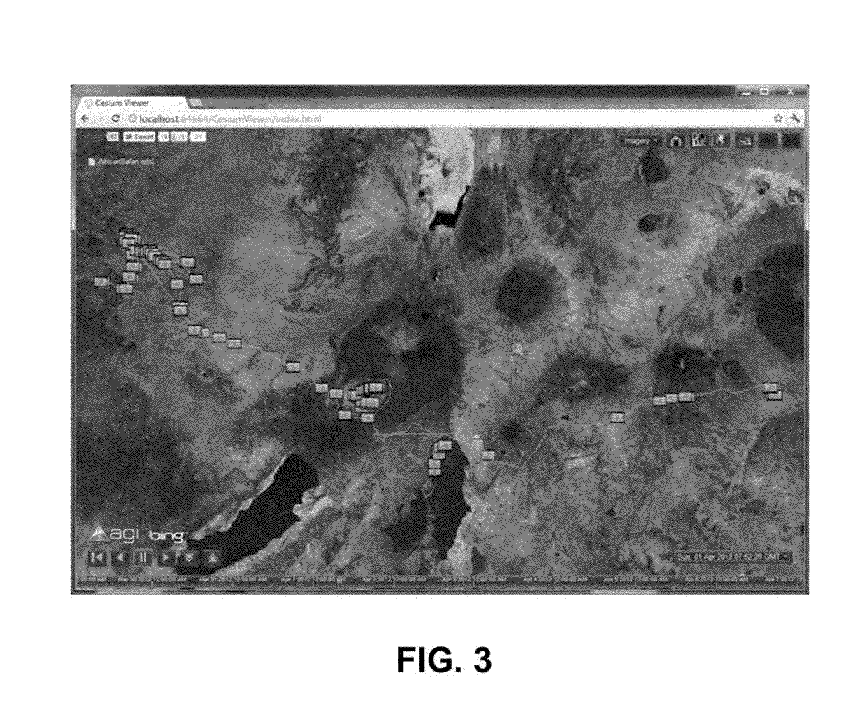

Referring now to FIG. 3, an annotation of a digital terrain database image based on GPS information is illustrated. In this illustration, an entire trip is represented. Images created on this trip are connected by a line which also illustrates the travel of the individual involved. In this instance, a GPS logger keeps track of the location of the individual during the course of the trip. As can be seen from this image, photographs are not present along every location where the traveler traveled. However, where pictures have been taken, they are depicted as superimposed over the travel line as recorded by the GPS logger. In this view, however, a user can also request an image to be displayed together with an icon indicating the location of a traveler along a displayed route. Because the database is populated with images having additional information stored with them, a user can also ask for images that are not produced by the traveler yet are relevant to where the traveler is located at any particular point in time.

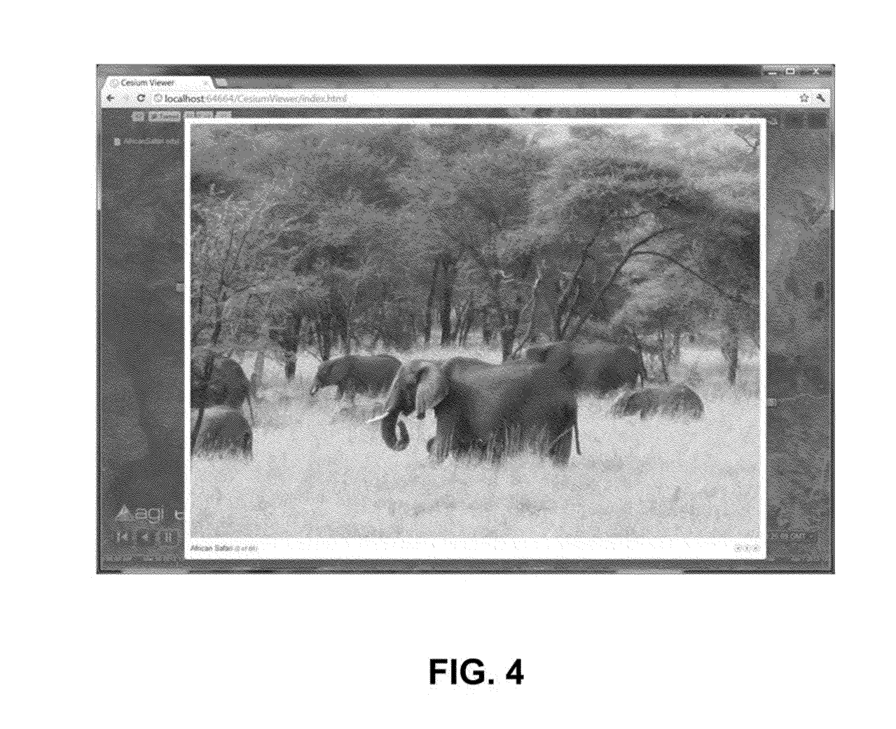

Referring now to FIG. 4, when a user clicks on a camera icon, an image associated with that camera is immediately displayed.

As can be seen in FIG. 4, this image is directly associated with a particular camera icon image that can be seen over the path of the traveler (FIG. 3). If desired by a user, other information can be displayed relating to, in this case, the type of elephant involved, comments of the owner of the camera system, current events for the area in which the image was located, and other information stored and associated with the particular image. For example, and without limitation, a user may also be able to obtain news information concerning whether this particular animal is on an endangered species list and whether or not there have been instances of poaching that endanger the animal in question.

Using the system of the various embodiments illustrated herein, a user can also be able to obtain information about physical objects in a particular scene. For example, in planning for embassy locations in various parts of the world it may be useful to understand the ingress and egress routes for a particular planned embassy site. Rather than sending an individual to take a whole series of pictures throughout a city, the systems and methods illustrated herein can take a series of augmented images from a variety of different sources and assemble them for a particular task such as ingress and egress planning. In such an instance, photogrammetric processes may be utilized to take a series of images, rectify those images and register them to a common orientation and display them from any variety of angles for subsequent analysis.

In another alternate embodiment, the system may be utilized to assist in disaster recovery. In this application, a disaster recovery authority can analyze an area that has been struck by adverse weather, terrorism, war, or other types of disruption and be able to determine what existed in what location prior to the disaster in question. This may then assist in determining what structures survived the hest and what building techniques assisted in that survival. This information may then be used for later planning. In addition, it is critical to determine what buildings existed where in order to assess the toll on human life and to aid in search and rescue operations. In this instance it would be extremely useful to understand what structures existed at any particular location.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

The various illustrative logical blocks, modules, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a computer-readable medium. Computer-readable media include both computer storage media and communication media including any Medium that facilitates transfer of a computer program from one place to another. A storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures and that may be accessed by a computer.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein. Further, any reference to claim elements in the singular, for example, using the articles “a,” “an,” or “the,” is not to be construed as limiting the element to the singular.

1. A system for providing augmented image database:
a memory;
a datastore; and
a processor coupled to the memory, wherein the processor is configured with processor-executable instructions to perform operations comprising:
receiving and storing images in an image database;
receiving and storing orientation data for each image in the image database, wherein the orientation data is indicative of the orientation of the image capture device that captured a particular image;
receiving and storing a time of image acquisition of each image in the image database;
receiving and storing location data for each image in the image database, wherein the location data is indicative of a location where the particular image was captured;
creating a timeline for one or more images selected from the image database;
generating a graphical representation Of a geographic location from a digital terrain database;
overlaying on the graphical representation the timeline an image icon for each of the selected images indicating the location where each of the selected images was captured;
sending the graphical representation to a user device;
receiving from the user device a selection of an image icon from the graphical representation; and
sending an image associated with the selected image icon to the user device.

2. The system of claim 1, wherein the processor is further configured with processor executable instructions to perform additional operations comprising sending the orientation data, the time of image acquisition and the location data for the image associated with the selected icon.

3. The system of claim 1, wherein the operation of generating a graphical representation of a geographic location from a digital terrain database comprises generating a map.

4. The system of claim 2, wherein the processor is further configured with processor executable instructions to perform additional operations comprising:
searching the image database for additional images obtained at a different time than the image associated with the selected icon;
alerting the user device of the presence of the additional images;
receiving from the user device a selection of one or more of the additional images; and
sending the additional images to the user device.

5. The system of claim 1, wherein the operation of receiving and storing location data comprises storing GPS data logs associated with each image in the image database.

6. The system of claim 5, wherein the GPS data log is obtained from individual GPS logging equipment.

7. The system of claim 5, wherein the GPS data log is obtained from a GPS logging capability integrated with a sensor from which the image is obtained.

8. The system of claim 1, wherein the images are selected from the group consisting of still images and video images.

9. A method for creating, a database for visualizing images comprising:
receiving and storing by a processor images in an image database;
receiving and storing by the processor orientation data for each image in the image database, wherein the orientation data is indicative of the orientation of the image capture device that captured a particular image;
receiving and storing by the processor a time of image acquisition of each image in the image database;
receiving and storing by the processor location data for each image in the image database, wherein the location data is indicative of a location where the particular image was captured;
creating by the processor a timeline for one or more images selected from the image database;
generating by the processor a graphical representation of a geographic location from a digital terrain database;
overlaying by the processor on the graphical representation the timeline an image icon for each of the selected images indicating the location where each oldie selected images was captured;
sending by the processor the graphical representation to a user device;
receiving by the processor from the user device a selection of an image icon from the graphical representation; and
sending by the processor an image associated with the selected image icon to the user device.

10. The method of claim 9 further comprising sending by the processor the orientation data, the time of image acquisition and the location data for the image associated with the selected icon.

11. The method of claim 9, wherein generating a graphical representation of a geographic location from a digital terrain database comprises generating a map.

12. The method of claim 10 further comprising:
searching using the processor the image database for additional images obtained at a different time than the image associated with the selected icon;
alerting by the processor the user device of the presence of the additional images;
receiving by the processor from the user device a selection of one or more of the additional images; and
sending by the processor the additional images to the user device.

13. The method of claim 9, wherein receiving and storing location data comprises storing GPS data logs associated with each image in the image database.

14. The method of claim 13, wherein the GPS data log is obtained from individual GPS logging equipment.

15. The method of claim 13, wherein the GPS data log is obtained from a GPS logging capability integrated with a sensor from which the image is obtained.

16. The method of claim 9, wherein the images are selected from the group consisting of still images and video images.

17. A method for aiding in disaster recovery, the method comprising:
receiving and storing by a processor images from an image recording device (IRD) in an image database;
receiving and storing by the processor IRD orientation data for each image in the image database;
selecting by the processor common object points imaged in the recorded images;
photogrammetrically processing by the processor the common image points thereby permitting registration of images one to another;
receiving by the processor a request for images of a particular location;
displaying by the processor all registered images in a common orientation in response to the request;
receiving by the processor a request for a specific category of augmented data about the images being displayed; and
displaying by the processor the specific category of augmented data together with the requested images.

18. The method of claim 17, wherein the specific category of augmented data comprises resident identification for structures in the displayed images.

19. A method for aiding in area construction, the method comprising:
receiving and storing by a processor images from an image recording device (IRD) in an image database;
receiving and storing by the processor IRD orientation data for each image in the image database;
selecting by the processor common object points imaged in the recorded images;
photogrammetrically by the processor processing the common image points thereby permitting registration of images one to another;
receiving by the processor a request for images of a particular location;
displaying by the processor all registered images in a common orientation in response to the request;
receiving by the processor a request for a specific category of augmented data about the images being displayed; and
displaying by the processor the specific category of augmented data together with the requested images.

20. The method of claim 19, wherein the specific category of augmented data for structures in the displayed images comprises data from the group consisting of building code data and civil improvement data.
